(19) United States
(12) Patent Application Publication
(10) Pub. No.: US 2026/0216964 A1
(43) Pub. Date: Jul. 30, 2026

(54) LAMINATED PARTS CONTAINING A HARD POLYURETHANE OUTER LAYER AND METHODS FOR THEIR PRODUCTION

(71) Applicant: Covestro LLC, Pittsburgh, PA (US)

(72) Inventors: Merle W. LESKO, McDonald, PA (US); Ronald L. ZACOUR, Washington, PA (US)

(21) Appl. No.: 19/146,377

(22) PCT Filed: Dec. 28, 2023
(86) PCT No.: PCT/US2023/086125

§ 371 Date: Jul. 8, 2025

Related U.S. Application Data
(60) Provisional application No. 63/480,154, filed on Jan. 17, 2023.

(51) Int. Cl. B29C 67/24; B29K 75/00; B29K 105/00; B29K 105/12; B29K 309/08

(52) U.S. Cl. CPC B29C 67/246; B29K 2075/00; B29K 2105/12; B29K 2105/253; B29K 2309/08; B29K 2995/007

(57) ABSTRACT

Laminated parts are described that include a core, a fiber layer arranged on each side of the core and impregnated with a polyurethane resin, and an outer polyurethane layer. The outer polyurethane layer comprises the cured reaction product of a reaction mixture that includes a polyisocyanate and an isocyanate-reactive composition having an overall hydroxyl number of 300 to 700 mg KOH/g. The isocyanate-reactive composition includes (i) a polyether polyol having a having a hydroxyl functionality of 2 to 4 and a hydroxyl number of 20 to 60 mg KOH/g, (ii) a polyol having a hydroxyl functionality of 1.5 to 5.0 and a hydroxyl number of 200 to 600 mg KOH/g and comprising an amine-initiated polyether polyol, and (iii) a glycol having a molecular weight of 62 to 399 g/mol and a hydroxyl functionality of 1.8 to 2.2. Methods for making such laminated parts are also described.

### FIELD

This specification pertains generally to laminated parts that include an outer polyurethane layer, to related polyurethane sandwich materials, methods for their manufacture and their use in producing automotive parts, such as load floors. The outer polyurethane layer is a hard layer that is resistant to distortion upon exposure to elevated temperatures.

### BACKGROUND

Fiber-reinforced sandwich panels are used to produce a variety of laminated automotive parts, such as load floors. These parts are sometimes produced by arranging a fiber layer on each side of a honeycomb core and then impregnating the fiber layer with a polyurethane resin that bonds the layers together. The part is then press molded under exposure to heat before the polyurethane resin cures. In some cases, an outer layer of Class A surface quality may be positioned on one of the polyurethane impregnated fiber layers and another layer, such as a textile layer, positioned on the other.

In some applications, however, it may be desirable to provide a laminated automotive part, such as a load floor, with a hard outer layer. Such a hard outer layer could make the suitable for use as a mobile work surface, such as a desk. To be viable, however, the hard outer layer must be resistant to distortion upon exposure to elevated temperatures, such as may be experienced in automotive applications. In addition, the hard layer must be produced using a composition that exhibits properties, such as reactivity profile, that is capable of successful application by using a reaction injection molding technique (RIM process), which is commonly used to produce fiber-reinforced sandwich panels.

The present invention was made in view of the foregoing.

### SUMMARY

In certain respects, this disclosure relates to laminated parts. The laminated parts comprise: (a) a core; (b) a fiber layer arranged on each side of the core and impregnated with a polyurethane resin, and (c) an outer polyurethane layer that is different from the polyurethane impregnated fiber layer and that is deposited over at least a portion of at least one polyurethane impregnated fiber layer. The outer polyurethane layer comprises the cured reaction product of a reaction mixture comprising (1) a polyisocyanate, and (2) an isocyanate-reactive composition having an overall hydroxyl number of 300 to 700 mg KOH/g. The isocyanate-reactive composition comprises: (i) a polyether polyol having a having a hydroxyl functionality of 2 to 4 and a hydroxyl number of 20 to 60 mg KOH/g, (ii) a polyol having a hydroxyl functionality of 1.5 to 5.0 and a hydroxyl number of 200 to 600 mg KOH/g and comprising an amine-initiated polyether polyol; and (iii) a glycol having a molecular weight of 62 to 399 g/mol and a hydroxyl functionality of 1.8 to 2.2.

In other respects, this disclosure relates to methods for making laminated parts. The methods comprise: (a) inserting a sandwich structure into a mold cavity, wherein the sandwich structure comprises: (1) a core, and (2) a fiber layer arranged on each side of the core, each fiber layer being impregnated with a polyurethane resin; (b) closing the mold; (c) injecting a polyurethane-forming reaction mixture via a RIM process into the cavity; (d) allowing the reaction mixture to react in the closed mold to form an outer polyurethane layer deposited over at least a portion of at least one of the polyurethane impregnated fiber layers; (e) opening the mold; and (f) removing the laminated part from the opened mold. In these processes, the polyurethane-forming reaction mixture comprises: (1) a polyisocyanate; and (2) an isocyanate-reactive composition having an overall hydroxyl number of 300 to 700 mg KOH/g, in which the isocyanate-reactive composition comprises: (i) a polyether polyol having a having a hydroxyl functionality of 2 to 4 and a hydroxyl number of 20 to 60 mg KOH/g, (ii) a polyol having a hydroxyl functionality of 1.5 to 5.0 and a hydroxyl number of 200 to 600 mg KOH/g and comprising an amine-initiated polyether polyol, and (iii) a glycol having a molecular weight of 62 to 399 g/mol and a hydroxyl functionality of 1.8 to 2.2.

### DETAILED DESCRIPTION

Various implementations are described and illustrated in this specification to provide an overall understanding of the structure, function, properties, and use of the disclosed inventions. It is understood that the various implementations described and illustrated in this specification are non-limiting and non-exhaustive. Thus, the invention is not limited by the description of the various non-limiting and non-exhaustive implementations disclosed in this specification. The features and characteristics described in connection with various implementations may be combined with the features and characteristics of other implementations. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132 (a). The various implementations disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132 (a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described implementations. Further, the use of a singular noun includes the plural, and the use of a plural noun includes the singular, unless the context of the usage requires otherwise.

As used herein, the term “functionality” refers to the average number of reactive hydroxyl groups, —OH, present per molecule of polyol and refers to the theoretical average nominal functionality of the polyol, that is, the functionality calculated based on the average number of hydroxyl groups per molecule of starter(s), and their relative amounts, used to produce the polyol. In producing a polyurethane, the hydroxyl groups react with isocyanate groups, —NCO, that are attached to an isocyanate compound. The term “hydroxyl number” refers to the number of reactive hydroxyl groups available for reaction, and is expressed as the number of milligrams of potassium hydroxide equivalent to the hydroxyl content of one gram of the polyol, determined according to ASTM D4274-16. The term “equivalent weight” refers to the weight of a compound divided by its valence. For a polyol, the equivalent weight is the weight of the polyol that will combine with an isocyanate group, and may be calculated by dividing the molecular weight of the polyol by its functionality. The equivalent weight of a polyol may also be calculated by dividing 56,100 by the hydroxyl number of the polyol-Equivalent Weight (g/eq)=(56.1×1000)/OH number. As used herein, equivalent weights and molecular weights of a polymer are number average equivalent weights and number average molecular weights respectively.

As indicated, certain implementations of this specification are directed to laminated parts. These laminated parts comprise a core. The core may be constructed of metal, plastic, natural material and/or paper. Suitable metals include aluminum, magnesium and alloys thereof. Suitable plastics include polyamides, polyesters, polycarbonates, polypropylene, polystyrene, ABS, polyamide imide (PAI) and mixtures thereof. The plastic can be reinforced or non-reinforced, filled or unfilled. Examples of natural materials are wood, flax, sisal, jute, and hemp. As used herein, the term “paper” refers to any type of paper, including multi-layer paper, cardboard, and resin-impregnated paper.

In some implementations, the core has a large number of cavities. The cavities can be of any geometrical shape. They can be angular or round channels, pores or bubbles, for example. The cavities can be arranged regularly or irregularly. In some embodiments, the core has a corrugated, angled, honeycomb or foam-like profile. The core can, for example, be a corrugated metal or corrugated cardboard. Similar to a corrugated metal or corrugated cardboard, the core can also be angled rather than corrugated, with, for example, a rectangular or triangular shape. In addition, similar to a corrugated metal or corrugated cardboard, the core can also be made from plastic. An angled or corrugated plastic profile can be extruded, for example. A multi-wall sheet, for example, can also be used as a plastic core.

In some implementations, the core has a thickness of 5 to 50 millimeters. Due to a large number of cavities, the weight of the core may be low in relation to its thickness. In some embodiments, the core has a density of 10 to 1000 kg/m³.

The laminated parts of this specification comprise a fiber layer arranged on each side of the core. Suitable fiber layers include, for example, fiberglass mats, chopped fiberglass strand mats, random layers of fiberglass, fiberglass fabric, cut or ground glass or mineral fibers, natural fiber mats and knitted fabrics, cut natural fibers and fiber mats, non-wovens and knitted fabrics based on polymer, carbon or aramid fibers and mixtures thereof. Suitable natural materials for the fiber layers include, but are not limited to, flax, sisal, jute and hemp. The fiber layers on each side of the core can be the same or different.

These fiber layers are arranged on or applied to both sides of the core, and impregnated with polyurethane resin. The thickness of the fiber layers is, in some embodiments, 0.1 to 2 millimeters. The weight per unit area of the fiber layers is, in some embodiments, 225 to 1200 g/m².

A polyurethane resin at least partially penetrates the fiber layers and the core, thus impregnating the fiber layers. The polyurethane resin thus, in some embodiments, partially or entirely fills the cavities of the core. The polyurethane resin serves to bond together the layers, which are press molded under exposure to heat before the polyurethane resin cures. The polyurethane resin fixes the fibers and forms the surface of a composite component, giving it a high strength and rigidity by bonding the layers together. This composite, comprising a core and a fiber layer arranged on each side of the core that is impregnated with a polyurethane resin is also referred to herein as a “sandwich structure”.

The polyurethane resin system that is used to impregnate the fiber layer can be a one-component or multi-component system, e.g., a two-component system. It can be foaming or non-foaming.

In some implementations, the polyurethane resin that impregnates the fiber layer comprises the reaction product of a reaction mixture comprising: (1) at least one polyisocyanate; (2) at least one polyol constituent with an average OH number from 300 to 700, comprising, in some embodiments, at least one short-chain and one long-chain polyol, the initial polyols having a hydroxyl functionality of 2 to 6; (3) water; (4) activators; (5) stabilizers; and, optionally, (6) other auxiliary materials, mold release agents and additives.

Suitable polyol constituents include, but are not limited to, polyols with at least two hydrogen atoms which are reactive with isocyanate groups, such as polyester polyols and polyether polyols.

Suitable polyisocyanates include, but are not limited to, polymeric isocyanates of the diphenylmethane disocyanate series (pMDI types), prepolymers thereof, or crude MDI.

In certain embodiments, water is employed in an amount of 0.1 to 3.0, such as 0.3 to 2.0 parts, per 100 parts of the polyol formulation.

Normal activators for the expansion and crosslinking reaction such as, for example, amines or metal salts may be used for catalysis.

Suitable foam stabilizers include polyether siloxanes, including water-soluble polyether siloxanes. These compounds generally have a copolymer of ethylene oxide and propylene oxide combined with a polydimethylsiloxane radical. Foam stabilizers of this type are described in, for example, U.S. Pat. Nos. 2,834,748, 2,917,480 and 3,629,308, the disclosures of which are herein incorporated by reference. Polysiloxane-polyoxyalkylene copolymers branched by allophanate groups as described in U.S. Pat. Nos. 4,096,162 and 4,163,830, the disclosures of which are herein incorporated by reference, are also suitable.

Other organopolysiloxanes, oxyethylated alkyl phenols, oxyethylated fatty alcohols, paraffin oils, esters of castor oil or ricinoleic acid, Turkey red oil and groundnut oil and cell regulators such as paraffins, fatty alcohols and dimethylpolysiloxanes are also suitable. Oligomeric polyacrylates with polyoxyalkylene and fluoroalkane radicals as side groups are further suitable for improving and/or stabilising the emulsifying action, dispersal of the filler, and the cellular structure. Surfactants are normally employed in quantities of 0.01 to 5 parts by weight per 100 parts by weight of polyol.

Other auxiliary materials, mold release agents and additives may optionally be incorporated in the reaction mixture for preparing the polyurethane resin. These include, for example, surface-active additives such as emulsifiers, flame retardants, chain extenders, crosslinking agents, nucleating agents, oxidation retardants, lubricants and mold release agents, dyes, dispersing aids and pigments.

The constituents are reacted in quantities such that, in some embodiments, the equivalence ratio of NCO groups in the polyisocyanate component (1) to the sum of the hydrogens in constituents (2) and (3), and possibly (5), which are reactive with isocyanate groups, is from 0.8:1 to 1.4:1, such as 0.9:1 to 1.3:1.

In some embodiments, the weight per unit area of the cured polyurethane resin that impregnates the fiber layer is 400 to 1200 g/m².

The foregoing sandwich structures can be produced by, for example, applying a fiber layer to each side of the core and applying the initial polyurethane constituents to the fiber layers. Alternatively, fibers may be introduced onto the core through the flow of raw polyurethane materials, using a suitable mixer head technique. The polyurethane resins may be produced by, for example, the one-shot or prepolymer process.

As previously indicated, the laminated parts of this specification also include an outer polyurethane layer that is different from the polyurethane impregnated fiber layer and that is deposited over at least a portion of at least one polyurethane impregnated fiber layer. The outer polyurethane layer comprises the cured reaction product of a polyurethane-forming reaction mixture comprising an organic di- and/or polyisocyanate (sometimes collectively referred to herein as “isocyanate”).

Suitable isocyanates for use in preparing the outer polyurethane layer include aliphatic, cycloaliphatic, araliphatic, aromatic and heterocyclic polyisocyanates. Exemplary isocyanates are those of the formula:

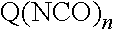

in which n is 2, 3 or 4 and Q is an aliphatic hydrocarbon radical with 2 to 18, such as 6 to 10 carbon atoms, a cycloaliphatic hydrocarbon radical with 4 to 15, such as 5 to 10 carbon atoms, an aromatic hydrocarbon radical with 6 to 15, such as 6 to 13 carbon atoms, or an araliphatic hydrocarbon radical with 8 to 15, such as 8 to 13 carbon atoms.

In some embodiments, the isocyanate comprises ethylene diisocyanate, 1,4-tetramethylene diisocyanate, 1,6-hexamethylene diisocyanate (HDI), 1,12-dodecane diisocyanate, cyclobutane-1,3-diisocyanate, cyclohexane-1,3-and-1,4-cyclohexane diisocyanate and any mixtures of these isomers, 1-isocyanato-3,3,5-trimethyl-5-isocyanatomethyl cyclohexane, 2,4- and 2,6-hexahydrotoluylene diisocyanate and any mixtures of these isomers, hexahydro-1,3-and-1,4-phenylene diisocyanate, perhydro-2,4′- and -4,4′-diphenylmethane diisocyanate, 1,3- and 1,4-phenylene diisocyanate, 1,4-durene diisocyanate (DDI), 4,4′-stilbene diisocyanate, 3,3′-dimethyl-4,4′-biphenylene diisocyanate (TODI) 2,4- and 2,6-toluylene diisocyanate (TDI) and any mixtures of these isomers, diphenylmethane-2,4′- and/or -4,4′-diisocyanate (MDI), naphthylene-1,5-diisocyanate (NDI), or a mixture of any two or more thereof.

Other suitable isocyanates include triphenylmethane-4,4′,4″-triisocyanate, polyphenyl-polymethylene polyisocyanates, as obtained by condensation of aniline with formaldehyde and subsequent phosgenation, m- and p-isocyanatophenylsulfonyl isocyanates, perchlorinated aryl polyisocyanates, polyisocyanates having carbodiimide groups, norbornane diisocyanates, polyisocyanates having allophanate groups, polyisocyanates having isocyanurate groups, polyisocyanates having urethane groups, polyisocyanates having acylated urea groups, polyisocyanates having biuret groups, polyisocyanates produced by telomerisation reactions, polyisocyanates having ester groups, reaction products of the above-mentioned isocyanates with acetals and polyisocyanates containing polymer fatty acid esters.

It is of course possible to use mixtures of any two or more of the above-named polyisocyanates.

In some embodiments, however, the isocyanate comprises 2,4- and 2,6-toluylene diisocyanate and any mixtures of these isomers (“TDI”), 4,4′-diphenylmethane diisocyanate, 2,4′-diphenylmethane diisocyanate, 2,2′-diphenylmethane diisocyanate and polyphenyl-polymethylene polyisocyanates which are produced by condensation of aniline with formaldehyde and subsequent phosgenation (“crude MDI”), and polyisocyanates having carbodiimide groups, uretonimine groups, urethane groups, allophanate groups, isocyanurate groups, urea groups or biuret groups (“modified polyisocyanates”), in particular such modified polyisocyanates that are derived from 2,4- and/or 2,6-toluylene diisocyanate or from 4,4′- and/or 2,4′-diphenylmethane diisocyanate. Naphthylene-1,5-diisocyanate and mixtures of the polyisocyanates named are also suitable.

In some embodiments, the isocyanate comprises a prepolymer having isocyanate groups which are produced by reacting a polyol and/or chain extender and/or crosslinking agent with at least one aromatic diisocyanate from the group TDI, MDI, TODI, DIBDI, NDI, and DDI, such as 4,4′-MDI to product a polyaddition product having urethane groups and isocyanate groups with an NCO content of 6 to 25 wt. %.

In certain implementations, the polyisocyanate comprises a methylene-bridged polyphenyl polyisocyanate and/or a prepolymer of methylene-bridged polyphenyl polyisocyanates having an average functionality of from 1.8 to 3.5, such as from 2.0 to 3.1, isocyanate moieties per molecule and an NCO content of 20 to 32 weight percent.

The reaction mixture used to form the outer polyurethane layer that is deposited over at least a portion of at least one of the polyurethane impregnated fiber layers also comprises an isocyanate-reactive composition having an overall hydroxyl number of 300 to 700 mg KOH/g, such as 300 to 500 mg KOH, or, in some cases, 300 to 400 mg KOH/g.

The isocyanate-reactive composition comprises a polyether polyol having a having a hydroxyl functionality of 2 to 4, such as 2.5 to 3.5 or 2.8 to 3.2 and a hydroxyl number of 20 to 60 mg KOH/g, such as 20 to 50 mg KOH/g, or 25 to 40 mg KOH/g.

Such polyether polyols can, for example, be produced by reaction of alkylene oxide, such as ethylene oxide, propylene oxide, butylene oxide, styrene oxide or epichlorohydrin, optionally in admixture or sequentially, to starting components (“starters”) with reactive hydrogen atoms, such as water, alcohols, ammonia or amines. Depending on the process control, such polyether polyols may be homopolymers, block copolymers, random copolymers, capped polymers or polymers tipped with a mixture of different epoxides. Specific examples of suitable starters for use in preparing such polyether polyols include, without limitation, compounds having two or more hydroxyl groups, such as water, 1,2-ethanediol, 1,2-propanediol, 1,3-propanediol, diethylene glycol, dipropylene glycol, triethylene glycol, tripropylene glycol, 1,2-butanediol, 1,3-butanediol, 1,4-butanediol, 1,2-hexanediol, 1,3-hexanediol, 1,4-hexanediol, 1,5-hexanediol, 1,6-hexanediol, glycerol, trimethylolpropane, pentaerythritol, sorbitol and sucrose, castor oil, modified soybean oil. The starter compounds may be used alone or as mixtures.

In some implementations, the polyether polyol having a functionality of 2 to 4 and an OH number of 20 to 60 mg KOH/g has a propylene oxide content of 70 to 90% by weight or 75 to 85% by weight, and an ethylene oxide content of 10 to 30% by weight or 15 to 25% by weight, based on the total weight of alkylene oxide used to prepare the polyether polyol.

Moreover, in some implementations, the polyether polyol having a functionality of 2 to 4 and an OH number of 20 to 60 mg KOH/g is present in an amount of at least 30% by weight, such as 30 to 50% by weight or 30 to 40% by weight, based on total weight of the isocyanate-reactive composition used to produce the outer polyurethane layer.

As indicated earlier, the isocyanate-reactive composition of the reaction mixture used to form the outer polyurethane layer also comprises a polyol having a hydroxyl functionality of 1.5 to 5.0, such as 2 to 4, and a hydroxyl number of 200 to 600 mg KOH/g, such as 300 to 400 mg KOH/g. In some implementations, the polyol having a hydroxyl functionality of 1.5 to 5.0 and a hydroxyl number of 200 to 600 mg KOH/g is present in an amount of at least 20% by weight, such as 20 to 60% by weight, 30 to 50% by weight or 40 to 50% by weight, based on total weight of the isocyanate-reactive composition.

Suitable such polyols having a hydroxyl functionality of 1.5 to 5.0, such as 2 to 4, and a hydroxyl number of 200 to 600 mg KOH/g include, without limitation, polyether polyols, polyester polyols, and mixtures thereof.

For example, in some implementations, the polyol having a hydroxyl functionality of 1.5 to 5.0 and a hydroxyl number of 200 to 600 mg KOH/g comprises an amine-initiated polyether polyol, such as an aromatic amine-initiated polyether polyol.

As used herein, “aromatic amine-initiated polyether polyol” refers to a polyether polyol that is the reaction product of an H-functional starter comprising an aromatic amine, such as, toluenediamine (“TDA”), with alkylene oxide. In certain implementations, the aromatic amine employed has an amine functionality of at least 1, such as 1 to 3 or 1 to 2. Specific examples of suitable aromatic amines which can be used include crude TDA obtained by the nitration of toluene followed by reduction; 2,3-TDA, 3,4-TDA, 2,4-TDA, 2,6-TDA or mixtures thereof; aniline; 4,4′-methylene dianiline; methylene-bridged polyphenyl polyamines composed of isomers of methylene dianilines and triamines or polyamines of higher molecular weight prepared by reacting aniline with formaldehyde by methods known in the art. In some implementations, a mixture composed of 2,3-TDA and 3,4-TDA (commonly referred to as “o-TDA”) is used.

In addition to the aromatic amine, other H-functional starters may also be used to prepare the aromatic amine-initiated polyether polyol. These other H-functional starters include, for example, water, propylene glycol, glycerin, ethylene glycol, ethanol amines, diethylene glycol, or a mixture of any two or more thereof. As will be appreciated, it is possible to use a wide variety of individual starters in combination with one another. In some implementations, however, aromatic amine is the predominant or essentially sole H-functional starter used to produce the aromatic amine-initiated polyether polyol. This means that, in these implementations, aromatic amine is present in an amount of more than 50% by weight, such as at least 80% by weight, at least 90% by weight, or even 100% by weight, based on the total weight of H-functional starter used to produce the aromatic amine-initiated polyether polyol.

Any of a variety of alkylene oxides may be used to produce the amine-initiated polyether polyol, such as aromatic amine-initiated polyether polyol, such as, for example, ethylene oxide, propylene oxide, butylene oxide, amylene oxide and mixtures thereof. The alkylene oxides may be added individually, sequentially one after the other to form blocks or in a mixture to form a heteric polyether. The aromatic amine-initiated polyether polyols may have either primary or secondary hydroxyl end groups. In some implementations, propylene oxide is the primary alkylene oxide used to prepare the aromatic amine-initiated polyether polyol. This means that, in these implementations, propylene oxide is used in an amount of more than 50% by weight, such as at least 60% by weight, 60 to 90% by weight, 60 to 80% by weight or 60 to 70% by weight, based on the total weight of alkylene oxide used to prepare the aromatic amine-initiated polyether polyol. In some implementations, ethylene oxide is employed in a relatively small amount. Thus, in these implementations, ethylene oxide is present in an amount of no more than 50% by weight, such as no more than 40% by weight, 10 to 40% by weight, 20 to 40% by weight, or 30 to 40% by weight, based on the total weight of alkylene oxide used to prepare the aromatic amine-initiated polyether polyol.

Moreover, in some implementations, the amine-initiated polyether polyol, such as aromatic amine-initiated polyether polyol, is present in an amount of 1 to 20% by weight, 5 to 15% by weight, or 8 to 12% by weight, based on total weight of the isocyanate-reactive composition.

In some implementations, the polyol having a hydroxyl functionality of 1.5 to 5.0 and a hydroxyl number of 200 to 600 mg KOH/g comprises a polyol-initiated, such as an aliphatic polyol-initiated, polyether polyol that is different from the previously described amine-initiated polyether polyol. In some cases, such a polyol-initiated polyether polyol has a hydroxyl number of 200 to 500 mg KOH/g, 200 to 400 mg KOH/g, 200 to 300 mg KOH/g, 200 to 250 mg KOH/g, 230 to 250 mg KOH/g or, in some cases, 233 to 243 mg KOH/g, and a functionality of greater than 2 to 4, such as 2.5 to 3.5, or, in some cases, 3.0.

As used herein, “aliphatic polyol-initiated polyether polyol” refers to a polyether polyol that is the reaction product of an H-functional starter comprising an aliphatic alcohol with alkylene oxide. Such aliphatic alcohols include aliphatic divalent, trivalent and/or more valent alcohols, such as, for example, ethanediol, 1,2-propanediol, 1,3-propanediol, diethylene glycol, dipropylene glycol, 1,4-butanediol, 1,6-hexanediol, and glycerin, among others, including mixtures of any two or more thereof. In addition to the aliphatic alcohol, other H-functional starters may also be used to prepare the polyol-initiated polyether polyol, including, for example, the amines mentioned earlier with respect to the amine-initiated polyether polyol. In some implementations, however, aliphatic alcohol amine is the predominant or essentially sole H-functional starter used to produce the polyol-initiated polyether polyol. This means that, in these implementations, aliphatic alcohol is present in an amount of more than 50% by weight, such as at least 80% by weight, at least 90% by weight, or even 100% by weight, based on the total weight of H-functional starter used to produce the polyol-initiated polyether polyol. In some embodiments, the aliphatic alcohol starter comprises or, in some cases, consists of glycerin and the alkylene oxide comprises, or, in some cases, consists of propylene oxide.

In certain embodiments, the foregoing polyol-initiated polyether polyol is present in an amount of 10 to 30% by weight, such as 15 to 25% by weight, or 15 to 20% by weight, based on the total weight of the isocyanate-reactive composition. In certain embodiments, the polyol-initiated polyether polyol and the amine-initiated polyether polyol are present in a weight ratio of at least 1:1, such as 1:1 to 5:1, 1:1 to 2:1, or, in some cases 1.5:1 to 2:1.

In addition, in some implementations, the polyol having a hydroxyl functionality of 1.5 to 5.0 and a hydroxyl number of 200 to 600 mg KOH/g comprises an aromatic polyester polyol. Suitable aromatic polyester polyols include, for example, reaction products of an aromatic diacid or anhydride with a suitable glycol or triol. For example, polyester polyols can be the reaction product of a glycol and/or triol, such as ethylene glycol, propylene glycol, butylene glycol, 1,3-butanediol, neopentyl glycol, diethylene glycol, dipropylene glycol, triethylene glycol, tripropylene glycol, glycerol, trimethylolethane, trimethyolpropane, pentanediol, hexanediol, heptanediol, 1,3- and 1,4-dimethylol cyclohexane, or a mixture of any two or more thereof with an aromatic diacid or aromatic anhydride, such as, for example, phthalic acid, isophthalic acid, terephthalic acid, phthalic anhydride, or a mixture of any two or more thereof.

In certain implementations, the aromatic polyester polyol has an OH number of 150 to 410 mg KOH/g, such as 200 to 360 mg KOH/g or 300 to 360 mg KOH/g, and a functionality of 1.5 to 3, such as 1.9 to 2.5.

In some implementations, the aromatic polyester polyol is present in an amount of 10 to 30%, such as 15 to 25% by weight, or 15 to 20% by weight, based on the total weight of the isocyanate-reactive composition. In certain implementations, the aromatic polyester polyol and the amine-initiated polyether polyol are present in isocyanate-reactive composition in a weight ratio of at least 1:1, such as 1:1 to 5:1, or, in some cases 1:1 to 2:1 or 1.5:1 to 2:1.

In addition to the polyols described above, the isocyanate-reactive compositions used to form the outer polyurethane layer also comprise a glycol having a molecular weight of 62 to 399 g/mol, such as 62 to 200 g/mol, and a hydroxyl functionality of 1.8 to 2.2, such as 2.0. Suitable, but non-limiting, examples of such glycols include ethylene glycol, diethylene glycol, triethylene glycol, tetraethylene glycol, propylene glycol, dipropylene glycol, tripropylene glycol, tetrapropylene glycol, trimethylene glycol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol, as well as mixtures of any two or more thereof.

In some implementations, the foregoing glycol is present in an amount of present in an amount of 5 to 30%, such as 10 to 25% by weight, or 15 to 25% by weight, based on the total weight of the isocyanate-reactive composition. In certain implementations, the glycol comprises a mixture of glycols comprises (i) a glycol having a molecular weight of 62 to 110 g/mol, and (ii) a glycol having a molecular weight of 111 to 200 g/mol, wherein glycol (i) and glycol (ii) are present in a ratio, by weight, of at least 1:1, such as 1:1 to 5:1 or 1:1 to 2.1.

The reaction mixture used to form the outer polyurethane layer may further comprise other ingredients, such as catalysts and other additives.

Suitable catalysts include amine catalysts, such as tertiary amines. Exemplary tertiary amines include triethylamine, triethylenediamine, tributylamine, N-methyl morpholine, N-ethyl morpholine, N,N,N′,N′-tetramethyl ethylenediamine, pentamethyl diethylene triamine, pentamethyl dipropylene triamine, and higher homologs, 1,4-diazabicyclo-[2,2,2]-octane, N-methyl-N′-dimethylaminoethyl piperazine, bis-(dimethylaminoalkyl) piperazine, N,N′-dimethylbenzylamine, N,N-dimethylcyclohexylamine, N,N-diethylbenzylamine, bis-(N,N-diethylaminoethyl) adipate, N,N,N′,N′-tetramethyl-1,3-butane diamine, N,N-dimethyl-B-phenyl-ethylamine, bis-(dimethylaminopropyl) urea, bis-(dimethylaminopropyl) amine, 1,2-dimethylimidazole, 2-methylimidazole, monocyclic and bicyclic amidines, bis-(dialkylamino)-alkylethers, such as e.g. bis(dimethylaminoethyl) ethers, and tertiary amines having amide groups (such as formamide groups). Mannich bases composed of secondary amines, such as dimethylamine and aldehydes, such as formaldehyde, or ketones such as acetone, methylethylketone or cyclohexanone and phenols, such as phenol, nonylphenol or bisphenol, are also suitable as catalysts. Tertiary amines having hydrogen atoms active in relation to isocyanate groups as catalyst are, for example, triethanolamine, triisopropanolamine, N-methyldiethanolamine, N-ethyldiethanolamine, N,N-dimethyl ethanolamine, the reaction products thereof with alkylene oxides such as propylene oxide and/or ethylene oxide and secondary-tertiary amines. Amines with carbon-silicon bonds such as 2,2,4-trimethyl-2-silamorpholine and 1,3-diethylaminomethyl tetramethyl disiloxane, can be used as catalysts. In addition, nitrogen-containing bases such as tetraalkylammonium hydroxides, furthermore hexahydrotriazines, are also suitable catalysts.

Metal catalysts may be used in addition to, or in lieu of, the foregoing amine catalysts. Specific examples of such catalysts include organic metal compounds of tin, titanium, bismuth, in particular organic tin compounds. Tin (II) salts of carboxylic acids, such as tin (II) acetate, tin (II) octoate, tin (II) ethyl hexoate, tin (II) laurate and tin (IV) compounds, such as dibutyl tin oxide, dibutyl tin dichloride, dibutyl tin diacetate, dibutyl tin dilaurate, dibutyl tin maleate or dioctyl tin diacetate, may be employed.

Various other additives may be included in the reaction mixture that forms the outer polyurethane layer. These include, without limitation, emulsifiers, foam stabilizers, cell regulators, flame retardants, UV stabilizers, nucleating agents, oxidation retarders, stabilizers, colorants, dispersing agents and pigments. In some implementations, however, the reaction mixture that forms the outer polyurethane layer does not include blowing agent and, as such, the outer polyurethane layer is a non-foamed outer polyurethane layer.

The reactivity profile of the reaction mixture and the physical properties of the cured reaction product thereof are particularly suitable for producing a hard polyurethane outer layer for a laminated part of the type described herein that is resistant to deformation on exposure to elevated temperature and which can be advantageously produced using a RIM technique. For example, the reaction mixture may exhibit a gel time (the period of time from the point when a polyurethane composition is mixed to the point when a fiber string can be pulled out from the polyurethane composition, sometimes also referred to as fiber time or string time) of at least 15 seconds or at least 20 seconds and no more than 2 minutes, no more than 1 minute, or no more than 30 seconds at the processing temperature. In addition, the cured polyurethane outer layer may exhibit a Shore D hardness of at least 70 or at least 75 (measured according to ASTM D2240-15 (2021)), a tensile strength of at least 5,000 psi (measured according to ASTM D638-22), an elongation of at least 30% (measured according to ASTM D638-22), a flexural modulus of at least 225,000 psi (measured according to ASTM D 790-17), and/or a heat distortion temperature (HDT) of greater than 140° F. @ 66 psi, measured according to ASTM D648-18). Polyurethane-forming reaction mixtures suitable for producing the outer polyurethane layer described herein are commercially available and include certain products available from Covestro LLC under the Baydur® tradename, including one or more of Baydur® TB 100-15 and 100-30.

Certain embodiments of the present specification are directed to methods for making laminated parts. These methods comprise providing a mold having a cavity therein. Suitable molds include, for example, those made of aluminum or steel or metal-sprayed epoxide molds.

To improve demolding, the internal walls of the mold being used are optionally coated with an external mold release agent, such as a non-reactive, silicone-free, external mold release agent, such as a non-transferring wax.

According to the methods of this specification a sandwich structure of the type described earlier is inserted into the mold cavity and the mold is then closed. An outer polyurethane layer deposited over at least a portion of at least one of the polyurethane impregnated fiber layers of the sandwich structure is then produced by using a reaction injection molding technique (RIM process). In certain implementations, the quantity of the components of the reaction mixture to form the outer polyurethane layer(s) is selected so that the reaction mixture has an isocyanate index of 70 to 130, such as 80 to 120, or 90 to 110. As will be appreciated, “isocyanate index” means the quotient of the number of isocyanate groups and number of isocyanate-reactive groups multiplied by 100.

In some embodiments, the initial temperature of the reaction mixture introduced into the mold is within the range of 20 to 80° C., such as 30 to 70° C. and, in some embodiments, the temperature of the mold is within the range of 30 to 130° C., such as 40 to 80° C.

The methods of this specification comprise allowing the reaction mixture to react in the mold to form an outer polyurethane layer deposited over at least a portion of at least one of the polyurethane impregnated fiber layers and then removing the laminated part from the mold. In some embodiments, the molded laminated part is removed from the mold, i.e., demolded after a mold dwell time of from 5 to 180 seconds. In some cases, conditioning at a temperature of about 60 to 180° C. for a period of 30 to 120 minutes may follow demolding.

As indicated, the outer polyurethane layer described herein is deposited over at least a portion of at least one of the polyurethane impregnated fiber layers. In some embodiments, the outer polyurethane layer is deposited over both of the polyurethane fiber layers. In some embodiments, the outer polyurethane layer described herein entirely, or substantially entirely, coats one or both of the polyurethane impregnated fiber layers. In cases where the outer polyurethane layer described herein is not deposited over one of the polyurethane impregnated fiber layer, such layer may, if desired, have another layer, such as a decorative layer deposited thereover. Such a layer may comprise, for example, a metal foil or sheet, a compact thermoplastic composite made of, for example, PMMA (polymethyl methacrylate), ASA (acrylic ester modified styrene acrylonitrile terpolymer), PC (polycarbonate), PA (polyamide), PBT (polybutylene terephthalate) and/or PPO (polyphenylene oxide). Alternatively, such a layer may be a constructed of a textile material with a barrier of TPU (thermoplastic polyurethane) sheeting, compact or foamed plastic sheets and other spray-on or RIM polyurethane skins.

In some implementations where the outer polyurethane layer described herein is not deposited over one of the polyurethane impregnated fiber layers, the other polyurethane impregnated fiber layer may have a different polyurethane outer layer deposited thereover. For example, in some implementations, such a different polyurethane outer layer may comprise has a Class A surface. In addition, in some embodiments, such a different polyurethane layer may comprise a cured reaction product of a reaction mixture comprising: (1) a polyisocyanate; (2) a polyether polyol having a molecular weight of 800 Da to 25,000 Da and a functionality of 2 to 8; and (3) 0.5 to 15% by weight, based on the total weight of the reaction mixture, of a fatty acid ester having an isocyanate-reactive functionality of at least 1 and a hydroxyl number of 10 to 20 mg KOH/gram. Such polyurethane outer layers having a Class A surface are described in U.S. Pat. No. 11,124,615 B2 at col. 5, line 65 to col. 10, line 27, the cited portion of which being incorporated herein by reference.

Some suitable applications of the laminated parts of this specification within the automotive industry include, for example, roof, bonnet, rear wing, door or bottom plate modules, as well as load floors.

The non-limiting and non-exhaustive example that follows is intended to further describe a non-limiting and non-exhaustive implementation without restricting the scope of the implementation described in this specification.

### Example

The mold used for the experiment described below was a full size prototype load floor tool. The mold was installed on a press adjacent to a small cylinder type RIM machine. The mixhead was mounted in the middle of the tool for the injection of the RIM material. A previously made composite load floor panel (containing an inner honeycomb core a polyurethane-impregnated glass fiber layer arranged on each side of the core) was inserted into the tool and the tool was closed under tonnage. The RIM material was then applied to one side of the panel. The tool remained closed for the duration of two minutes before removing the finished part. The mold was heated with water lines to 175° F. The heat was maintained with electric thermolator units circulating water at the required temperature.

For the experiment, the mold cavity was cleaned using Chem Trend Mold cleaner MOC-10003 (N-Methyl pyrrolidone) to remove any residual external mold release and then wiped with water to neutralize any leftover mold cleaner. The mold cavity was prepared with a release agent consisting of a solvent based wax to promote release from the mold cavity of the hard outer polyurethane layer to be produced. A panel having a paper honeycomb core and a fiber layer arranged on each side of the core and impregnated with a polyurethane resin was then placed in the mold and the mold was closed.

For the experiment, the RIM machine throughput was set at 250 grams/second and the material temperatures were maintained at 95° F. for the “B” POLYOL SIDE and 90° F. for the “A” ISO SIDE. The shot weight was set for 1200 grams total and the material was injected into the tooling. A high pressure mixhead was attached to the middle of the tool and material was injected on one side of the panel. The tool was kept closed for 120 seconds before separating the two halves and opening the mold and demolding the part.

The “B” POLYOL SIDE included, in addition to amine catalyst and black colorant, a mixture of: (i) 10 to 30% by weight, based on total weight of the “B” POLYOL SIDE, of an aromatic polyester polyol having an OH number of 150 to 410 mg KOH/g and a functionality of 1.5 to 3; (ii) 30 to 50% by weight, based on total weight of the “B” POLYOL SIDE, of a polyether polyol having a hydroxyl number of 20 to 60 mg KOH/g and a functionality of 2 to 4; (iii) 10 to 30% by weight, based on total weight of the “B” POLYOL SIDE, of an aliphatic polyol-initiated polyether polyol having a hydroxyl number of 200 to 500 mg KOH/g and a functionality of greater than 2 to 4; (iv) 1 to 20% by weight, based on total weight of the “B” POLYOL SIDE, an o-TDA-initiated polyether polyol having a hydroxyl number of 200 to 400 mg KOH/g and a functionality of 1.5 to 5.0; and (v) 10 to 30% by weight, based on total weight of the “B” POLYOL SIDE of glycols having a molecular weight of 62 to 399 g/mol and a functionality of 1.8 to 2.2, the glycols being a combination of: (1) two glycols having a molecular weight of 62 to 110 g/mol and (2) one glycol having a molecular weight of 111 to 200 g/mol, wherein glycols (1) and glycol (2) were present in a ratio, by weight, of 1:1 to 2.1. The “A” ISO SIDE was an aromatic polymeric isocyanate based on 4,4-diphenylmethane-diisocyanate (MDI) having an NCO content of at least 31.0% by weight and a viscosity at 25° C. between 150-250 cps. The “B” POLYOL SIDE was mixed with the “A” ISO SIDE at a weight ratio of 100:85 “B” POLYOL SIDE to “A” ISO SIDE. The overall hydroxyl number of the “B” POLYOL SIDE was about 360 mg KOH/g.

The resulting outer polyurethane layer had a Shore D hardness 78 measured according to ASTM D2240-15 (2021) and a HDT of 178° F. @66 psi, measured according to ASTM D648-18.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A laminated part comprising:
(a) a core;
(b) a fiber layer arranged on each side of the core and impregnated with a polyurethane resin, and
(c) an outer polyurethane layer that is different from the polyurethane impregnated fiber layer and that is deposited over at least a portion of at least one polyurethane impregnated fiber layer,
wherein the outer polyurethane layer comprises the cured reaction product of a reaction mixture comprising (1) a polyisocyanate, and (2) an isocyanate-reactive composition having an overall hydroxyl number of 300 to 700 mg KOH/g and comprising:
(i) a polyether polyol having a having a hydroxyl functionality of 2 to 4 and a hydroxyl number of 20 to 60 mg KOH/g,
(ii) a polyol having a hydroxyl functionality of 1.5 to 5.0 and a hydroxyl number of 200 to 600 mg KOH/g and comprising an amine-initiated polyether polyol; and
(iii) a glycol having a molecular weight of 62 to 399 g/mol and a hydroxyl functionality of 1.8 to 2.2.

2. The laminated part of claim 1, wherein the core is constructed of paper and comprises cavities.

3-4. (canceled)

5. The laminated part of claim 1, wherein the fiber layer comprises fiberglass.

6-12. (canceled)

13. The laminated part of claim 1, wherein the polyether polyol having a functionality of 2 to 4 and an OH number of 20 to 60 mg KOH/g has a propylene oxide content of 70 to 90% by weight, and an ethylene oxide content of 10 to 30% by weight, based on the total weight of alkylene oxide used to prepare the polyether polyol.

14. The laminated part of claim 1, wherein the polyether polyol having a functionality of 2 to 4 and an OH number of 20 to 60 mg KOH/g is present in an amount of at least 30% by weight, based on total weight of the isocyanate-reactive composition used to produce the outer polyurethane layer.

15. (canceled)

16. The laminated part of claim 1, wherein the polyol having a hydroxyl functionality of 1.5 to 5.0 and a hydroxyl number of 200 to 600 mg KOH/g is present in an amount of 20 to 60% by weight, based on total weight of the isocyanate-reactive composition.

17-19. (canceled)

20. The laminated part of claim 1, wherein the amine-initiated polyether polyol is a reaction product of alkylene oxide with an H-functional starter comprising an aromatic amine that is present in an amount of more than 50% by weight, based on the total weight of H-functional starter used to produce the amine-initiated polyether and propylene oxide is present in an amount of more than 50% by weight, based on the total weight of alkylene oxide used to prepare the aromatic amine-initiated polyether polyol.

21. The laminated part of claim 1, wherein the amine-initiated polyether polyol is present in an amount of 1 to 20% by weight, based on total weight of the isocyanate-reactive composition.

22. The laminated part of claim 1, wherein the polyol having a hydroxyl functionality of 1.5 to 5.0 and a hydroxyl number of 200 to 600 mg KOH/g further comprises an aliphatic polyol-initiated, polyether polyol that is different from the amine-initiated polyether polyol, wherein the aliphatic alcohol is present in an amount of more than 50% by weight, based on the total weight of H-functional starter used to produce the aliphatic polyol-initiated polyether polyol.

23-24. (canceled)

25. The laminated part of claim 22, wherein the aliphatic polyol-initiated polyether polyol is present in an amount of 10 to 30% by weight, based on the total weight of the isocyanate-reactive composition.

26. The laminated part of claim 1, wherein the polyol having a hydroxyl functionality of 1.5 to 5.0 and a hydroxyl number of 200 to 600 mg KOH/g further comprises an aromatic polyester polyol.

27. (canceled)

28. The laminated part of claim 26, wherein the aromatic polyester polyol is present in an amount of 10 to 30%, based on the total weight of the isocyanate-reactive composition.

29-30. (canceled)

31. The laminated part of claim 1, wherein the glycol having a molecular weight of 62 to 399 g/mol and a hydroxyl functionality of 1.8 to 2.2 is present in an amount of present in an amount of 10 to 25% by weight, based on the total weight of the isocyanate-reactive composition.

32. The laminated part of claim 1, wherein the glycol having a molecular weight of 62 to 399 g/mol and a hydroxyl functionality of 1.8 to 2.2 comprises (i) a glycol having a molecular weight of 62 to 110 g/mol, and (ii) a glycol having a molecular weight of 111 to 200 g/mol, wherein glycol (i) and glycol (ii) are present in a ratio, by weight, of at least 1:1.

33. The laminated part of claim 1, wherein the outer polyurethane layer is a non-foamed outer polyurethane layer.

34. (canceled)

35. The laminated part of claim 1, wherein the outer polyurethane layer exhibits a Shore D hardness of at least 70 measured according to ASTM D2240-15 (2021).

36. The laminated part of claim 1, wherein the laminated part further comprises a second polyurethane outer layer having a Class A surface.

37. (canceled)

38. The laminated part of claim 1, wherein the reaction mixture has an isocyanate index of 70 to 130.

39. An automotive roof, bonnet, rear wing, door or bottom plate modules, or load floor comprising the laminated part of claim 1.

40. A method for making the laminated part of claim 1 comprising:
(a) inserting a sandwich structure into a mold cavity, wherein the sandwich structure comprises:
(1) a core, and
(2) a fiber layer arranged on each side of the core, each fiber layer being impregnated with a polyurethane resin;
(b) closing the mold;
(c) injecting the reaction mixture into the cavity via a RIM process;
(d) allowing the reaction mixture to react in the closed mold to form the outer polyurethane layer deposited over at least a portion of at least one of the polyurethane impregnated fiber layers;
(e) opening the mold; and
(f) removing the laminated part from the opened mold.

41-80. (canceled)
